(19) United States
(12) Patent Application Publication
(10) Pub. No.: US 2015/0377831 A1
(43) Pub. Date: Dec. 31, 2015

(54) DIGITAL MICROFLUIDIC DEVICES AND METHODS EMPLOYING INTEGRATED NANOSTRUCTURED ELECTRODEPOSITED ELECTRODES

(71) Applicant: The Governing Council of the University of Toronto, Toronto (CA)

(72) Inventors: Aaron R. Wheeler, Toronto (CA); Shana O. Kelley, Toronto (CA); Darius G. Rackus, Toronto (CA); Michael D.M. Dryden, Toronto (CA); Brian Lam, Vancouver (CA)

(21) Appl. No.: 14/752,411

(22) Filed: Jun. 26, 2015

Related U.S. Application Data
(60) Provisional application No. 62/018,378, filed on Jun. 27, 2014.

(51) Int. Cl. G01N 27/447; G01N 27/30; B01L 3/00

(52) U.S. Cl. CPC G01N 27/44791; B01L 3/502784; G01N 27/301; G01N 27/30; B01L 2200/027; B01L 2400/0424; B01L 2300/161

(57) ABSTRACT

Digital microfluidic devices, and methods for the control and fabrication thereof, and provided in which an integrated nanostructured electrodeposited electrode is provided such that the digital microfluidic array can be actuated to contact a droplet with the nanostructured electrodeposited electrode. In some embodiments, digital microfluidic devices are provided having an integrated electrochemical sensor, where the working electrode is provided in the form of a nanostructured electrodeposited electrode. Various methods of fabricating such integrated device are described, including methods that employ a lift-off process that exposes an underlying base electrode for the electrodeposition of a nanostructured electrodeposited electrode, while providing a hydrophobic surface for droplet transport.

### BACKGROUND

This present disclosure relates to digital microfluidic devices, and to electrochemical detection on via digital microfluidic devices.

Digital microfluidics is an emerging technology in which discrete liquid droplets are manipulated on the surface of an array of electrodes. Digital microfluidics has numerous complementary differences relative to conventional enclosed-microchannel-based fluidics, including reconfigurability (a generic device format can be used for any application) and control over all reagents. Digital microfluidics is typically implemented in a “two-plate” format, in which droplets are sandwiched between a bottom plate (bearing an array of electrodes coated with an insulator), and a top plate (bearing a ground electrode not coated with an insulator).

### SUMMARY

Digital microfluidic devices, and methods for the control and fabrication thereof, and provided in which an integrated nanostructured electrodeposited electrode is provided such that the digital microfluidic array can be actuated to contact a droplet with the nanostructured electrodeposited electrode. In some embodiments, digital microfluidic devices are provided having an integrated electrochemical sensor, where the working electrode is provided in the form of a nanostructured electrodeposited electrode. Various methods of fabricating such integrated device are described, including methods that employ a lift-off process that exposes an underlying base electrode for the electrodeposition of a nanostructured electrodeposited electrode, while providing a hydrophobic surface for droplet transport.

Accordingly, in a first aspect, there is provided a digital microfluidic device comprising:
a first substrate comprising an array of actuation electrodes, wherein said array of actuation electrodes is coated with a first dielectric layer and a first hydrophobic coating layer;
a second substrate comprising at least one secondary electrode, wherein said secondary electrode has formed thereon at least a second hydrophobic coating layer, wherein said second substrate is provided in a spaced relationship relative to said first substrate, defining a gap therebetween for droplet translation under electrical actuation of said array of actuation electrodes;
at least one integrated electrochemical sensor located on said first substrate or said second substrate, said integrated electrochemical sensor comprising:
   a reference electrode formed within a first aperture, wherein said first aperture is surrounded by dielectric; and
   a nanostructured electrodeposited working electrode extending, from a base electrode, through a second aperture surrounded by dielectric, and into said gap; and
   wherein said integrated electrochemical sensor is located such that a liquid droplet is in electrical communication with said nanostructured electrodeposited working electrode and said reference electrode when the liquid droplet is transported to a selected location under actuation of said array of actuation electrodes.

In another aspect, there is provided a digital microfluidic device comprising:
a substrate comprising an array of actuation electrodes, wherein said array of actuation electrodes is coated with a dielectric layer and a hydrophobic coating layer;
said substrate further comprising at least one secondary electrode for applying a potential to each actuation electrode;
at least one integrated electrochemical sensor located on said substrate, said integrated electrochemical sensor comprising:
   a reference electrode formed within a first aperture, wherein said first aperture is surrounded by dielectric; and
   a nanostructured electrodeposited working electrode extending, from a base electrode, through a second aperture surrounded by dielectric and into a region beyond said hydrophobic coating layer; and
   wherein said integrated electrochemical sensor is located such that a liquid droplet is in electrical communication with said nanostructured electrodeposited working electrode and said reference electrode when the liquid droplet is transported to a selected actuation electrode under actuation of said array of actuation electrodes.

In another aspect, there is provided a digital microfluidic device comprising:
a first substrate comprising an array of actuation electrodes, wherein said array of actuation electrodes is coated with a first dielectric layer and a first hydrophobic coating layer;
a second substrate comprising at least one secondary electrode, wherein said secondary electrode has formed thereon at least a second hydrophobic coating layer, wherein said second substrate is provided in a spaced relationship relative to said first substrate, defining a gap therebetween for droplet translation under electrical actuation of said array of actuation electrodes; and
a nanostructured electrodeposited electrode provided on said first substrate or said second substrate, said nanostructured electrodeposited electrode extending, from a base electrode, through an aperture surrounded by dielectric, and into said gap; and
wherein said nanostructured electrodeposited electrode is located such that a liquid droplet is in electrical communication with said nanostructured electrodeposited electrode when the liquid droplet is transported to a selected location under actuation of said array of actuation electrodes.

In another aspect, there is provided a digital microfluidic device comprising:
a substrate comprising an array of actuation electrodes, wherein said array of actuation electrodes is coated with a dielectric layer and a hydrophobic coating layer;
said substrate further comprising at least one secondary electrode for applying a potential to each actuation electrode;
a nanostructured electrodeposited electrode extending, from a base electrode, through an aperture surrounded by dielectric and into a region beyond said hydrophobic coating layer; and
wherein said nanostructured electrodeposited electrode is located such that a liquid droplet is in electrical communication with said nanostructured electrodeposited electrode when the liquid droplet is transported to a selected actuation electrode under actuation of said array of actuation electrodes.

In another aspect, there is provided a method of fabricating a nanostructured electrodeposited electrode on substrate that is configured for digital microfluidic droplet translation, the method comprising:
providing a substrate having a base electrode formed thereon;
coating at least a portion of the substrate with a dielectric layer and processing the dielectric layer to form an aperture over the base electrode, such that the aperture exposes the base electrode, and such that the aperture is surrounded by the dielectric layer, wherein at least one dimension of the aperture is less than approximately 50 microns;
spin coating a layer of photoresist onto the substrate;
processing the photoresist such that residual photoresist is retained in a region including the aperture;
spin coating a hydrophobic material onto the substrate and thermally processing the substrate to form a hydrophobic surface;
performing a lift-off process to remove the residual photoresist, thereby exposing the base electrode; and
performing an electrodeposition process to form a nanostructured electrodeposited electrode on the base electrode, such that the nanostructured electrodeposited electrode extends from the base electrode, through the aperture, and beyond the hydrophobic surface of the substrate;
wherein the thermal resistance temperature of the photoresist is greater than the thermal processing temperature employed for formation of the hydrophobic surface.

In another aspect, there is provided a method of performing electrochemical detection an analyte with a digital microfluidic device, the method comprising:
providing a digital microfluidic device as described above, wherein said nanostructured electrodeposited working electrode comprises one or more binding agents for binding the analyte thereto;
providing, on the digital microfluidic device, an analyte-containing droplet containing the analyte;
actuating the array of actuation electrodes such that the analyte-containing droplet is transported to the selected actuation electrode, whereby the analyte-containing droplet contacts the integrated electrochemical sensor;
actuating the array of actuation electrodes to transport the analyte-containing droplet to one or more neighbouring actuation electrodes and to return the analyte-containing droplet to the selected actuation electrode, such that the analyte-containing droplet is transported in a multidirectional path, thereby increasing the kinetics of the binding of the analyte to the nanostructured electrodeposited working electrode; and
performing electrochemical detection of the analyte bound to the nanostructured electrodeposited working electrode.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1A shows a cross-sectional view of a two-plate digital microfluidic device.

FIG. 1B shows a cross-sectional view of a one-plate digital microfluidic device.

FIGS. 2A-2D shows an overview of an example implementation of a digital microfluidic apparatus that includes an electrochemical sensor based on a nanostructured electrodeposited microelectrodes, where (A) illustrates the device design based on two glass plates for digital microfluidic and electrochemical sensing; (B) shows the four sensor regions in the top plate, which comprise of three nanostructured electrodeposited microelectrodes, a Ag reference electrode, and an Au counter electrode; (C) shows a scanning electron microscopy image of a nanostructured electrodeposited microelectrodes that was plated through a 30 μm aperture in a layer of SU-8; and (D) shows a cross-section of the two plates forming the digital microfluidic device (not to scale).

FIGS. 3A-J illustrate various example implementations of digital microfluidic devices with integrated nanostructured electrodeposited microelectrodes.

FIG. 4 is a flow chart describing an example method for forming an integrated microelectrode in substrate for subsequent assembly in a digital microfluidic device.

FIG. 5 shows an example implementation of a control system for controlling the digital microfluidic device and for performing measurements with a potentiostat.

FIG. 6 is an illustration of an example method of transporting a liquid droplet relative to a nanostructured electrodeposited microelectrode for increasing mixing and binding kinetics.

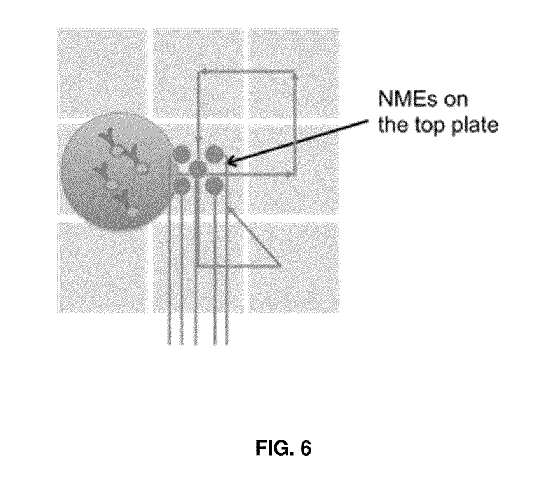

FIGS. 7A and 7B are plots showing (A) differential pulse voltammetry results of an HIV test discriminating between 5 μg/mL HIV-1 antibody (black) versus 5 μg/mL goat IgG (gray); and (B) differential pulse voltammetry results of a nucleic acid hybridization assay showing an increase in peak current as a result of DNA-PNA hybridization for complementary sample (black) and background solution (gray).

FIGS. 8A and 8B plot cyclic voltammetry responses of nanostructured electrodeposited microelectrodes presented with 20 mM K₃Fe(CN)₆ with either (A) an Au reference electrode or (B) an Ag reference electrode.

FIG. 9 is a table providing parameters for reference potential stability between Au and Ag reference electrodes for different devices.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Unless defined otherwise, all technical and scientific terms used herein are intended to have the same meaning as commonly understood to one of ordinary skill in the art.

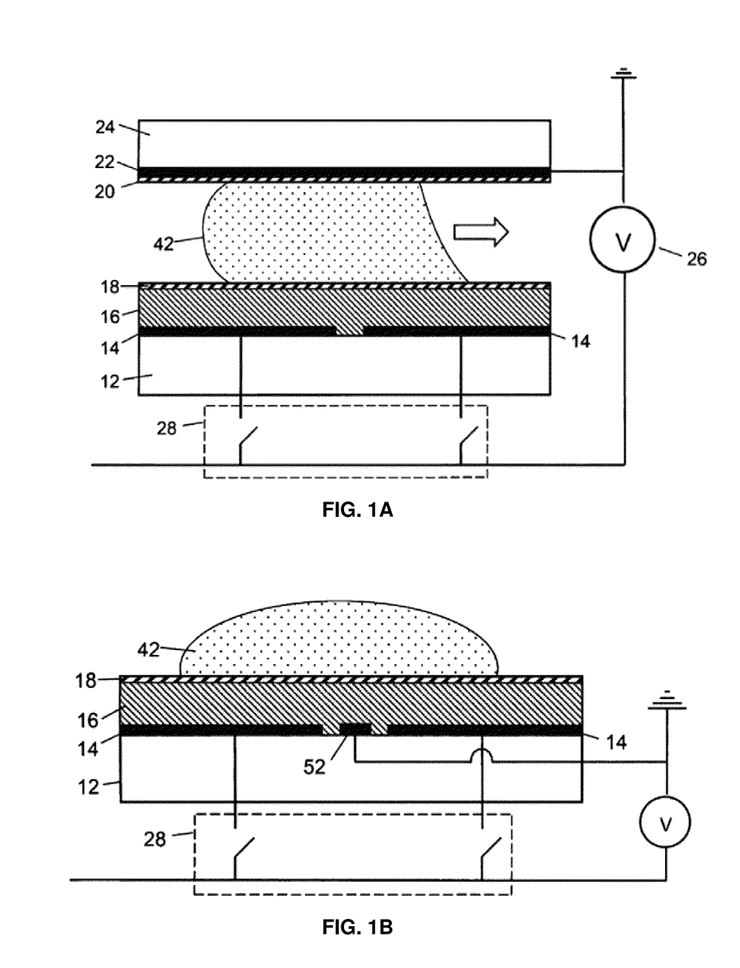

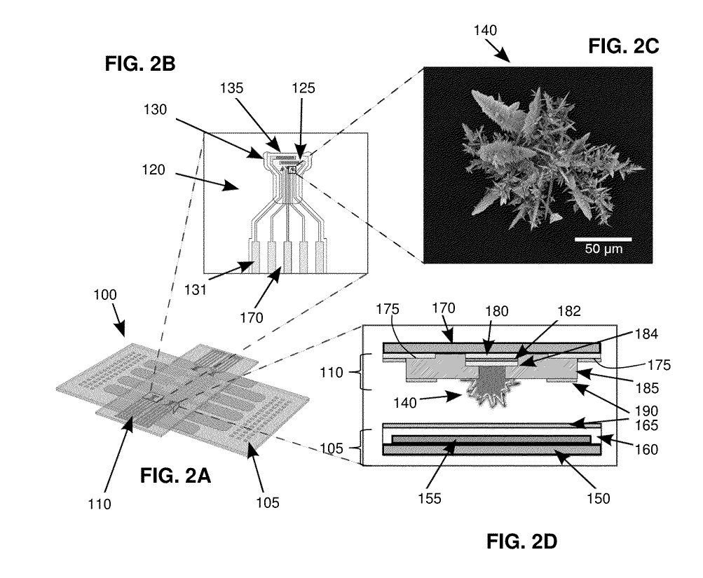

FIG. 1A is a cross-sectional view of a portion of an example microfluidic device, showing two adjacent actuation electrodes 14 of the array of actuation electrodes. Electrodes 14 (e.g. 10 nm Cr+, 100 nm Au) rest on a substrate layer 12 and are separated from each other by a dielectric material 16 (for example, 2 μm Parylene-C™). The device can have more than one dielectric layer. Located on top of dielectric material 16 is a hydrophobic layer 18 (for example, Teflon AF™, 50 nm). The array of actuating electrodes and exposed areas of substrate surface are thus covered by a working surface. Spaced above electrodes 14 and dielectric layer 16, on the other side of the gap, is a continuous secondary electrode 22 (or a plurality of secondary electrodes) coated on a substrate layer 24 (secondary electrode 22 is often referred to in the digital microfluidic literature as a reference electrode, but the term “secondary” is employed herein in order to avoid confusion with the reference electrode of an electrochemical sensor), and a hydrophobic layer 20 (for example Teflon AF™, 50 nm) is coated on secondary electrode 22. Alternatively, another dielectric layer can be deposited between layers 20, 22. Liquid droplets 42 rest in-between two hydrophobic layers 18 and 20. Electrodes 14, voltage source 26, and the continuous secondary electrode 22 together form an electric field, digitally manipulated by controller 28. For droplet manipulation, secondary electrode 22 are biased to a potential different from the actuating potential. A commonly used reference potential for secondary electrode 22 is ground. The upper hydrophobic layer 20, secondary electrode 22, and substrate layer 24 are substantially transparent to allow optical analysis of the assays. Furthermore, layers 20, 22, and 24 are not necessary to translate droplets.

While some aspects of the present disclosure involve the two-plate design of FIG. 1A, a one-plate design is also possible, as shown in FIG. 1B. In FIG. 1B, layers 20, 22, and 24 are removed. Rather than have a dedicated secondary electrode layer 22, the secondary electrode is patterned adjacent to electrodes 14, forming a continuous grid 52 separated from electrodes 14 by dielectric material 16. The continuous grid 52 extends in both directions defining the plane in which electrodes 14 are located.

Reference electrodes can also be coplanar with the top surface of the dielectric layer. In a device with multiple dielectric layers, secondary electrodes can be coplanar with the top surface of any dielectric layer, while being insulated from actuating electrodes 14. The design of secondary electrodes is not limited to a grid, e.g. they can be in a form of a wire or an array similarly to electrodes 14.

In various embodiments of the present disclosure, digital microfluidic devices are configured to include one or more nanostructured electrodeposited microelectrodes. The term “nanostructured electrodeposited microelectrode”, as used herein, refers to an electrode formed on a substrate, the electrode having a three-dimensional structure that extends from a base electrode, through an aperture surrounded by a dielectric, and into a region beyond surface of the substrate, where the electrode is characterized by sub-micron spatial features. Nanostructured electrodeposited microelectrodes comprise nanoscale surface morphology (e.g. surface features less than 1 micron, less than 100 nm, or less than 50 nm) and thus have an increased surface area relative to smooth electrodes. As disclosed in various example embodiments provided herein, nanostructured electrodeposited microelectrodes may be integrated with digital-microfluidic devices in order to provide sensitive electrodes for a wide range of applications, including electrochemical sensors, surface enhanced Raman detection, and high surface area affinity capture electrodes for various assays. As noted above, nanostructured electrodeposited microelectrodes are formed via an electrodeposition process, as disclosed, for example, in US Patent Publication No. US2011/0233075, titled “NANOSTRUCTURED MICROELECTRODES AND BIOSENSING DEVICES INCORPORATING THE SAME”, which Was filed on Sep. 1, 2009.

The incorporation of a nanostructured electrodeposited microelectrode into a digital microfluidic device may provide several benefits, when compared with conventional microfluidic-devices. For example, it has been found that nanostructured electrodeposited microelectrodes can be very fragile, and that fluidic pressures that are often produced within conventional channel-based microfluidic devices can damage and break off portions of nanostructured electrodeposited microelectrodes. In contrast, digital microfluidic droplet actuation is highly controllable, and can be employed to transport droplets into contact with nanostructured electrodeposited microelectrodes without inducing damage. Furthermore, the control over droplet transport within a digital microfluidic device allows for improved local mixing efficiency when compared to continuous flow microfluidic devices for which binding kinetics are often limited by diffusive transport. Finally, the small, nano-liter scale volumes of droplets that are typically employed with digital microfluidic devices are well suited to the small size of nanostructured electrodeposited microelectrodes, also increasing detection and/or binding efficiency.

In some embodiments, such nanostructured electrodeposited microelectrodes may be provided as a working electrode of an electrochemical sensor that is integrated with a digital microfluidic device. Nanostructured electrodeposited microelectrodes, due to their nanoscale surface morphology, may significantly improve the sensitivity and performance of digital microfluidic based electrochemical sensing devices.

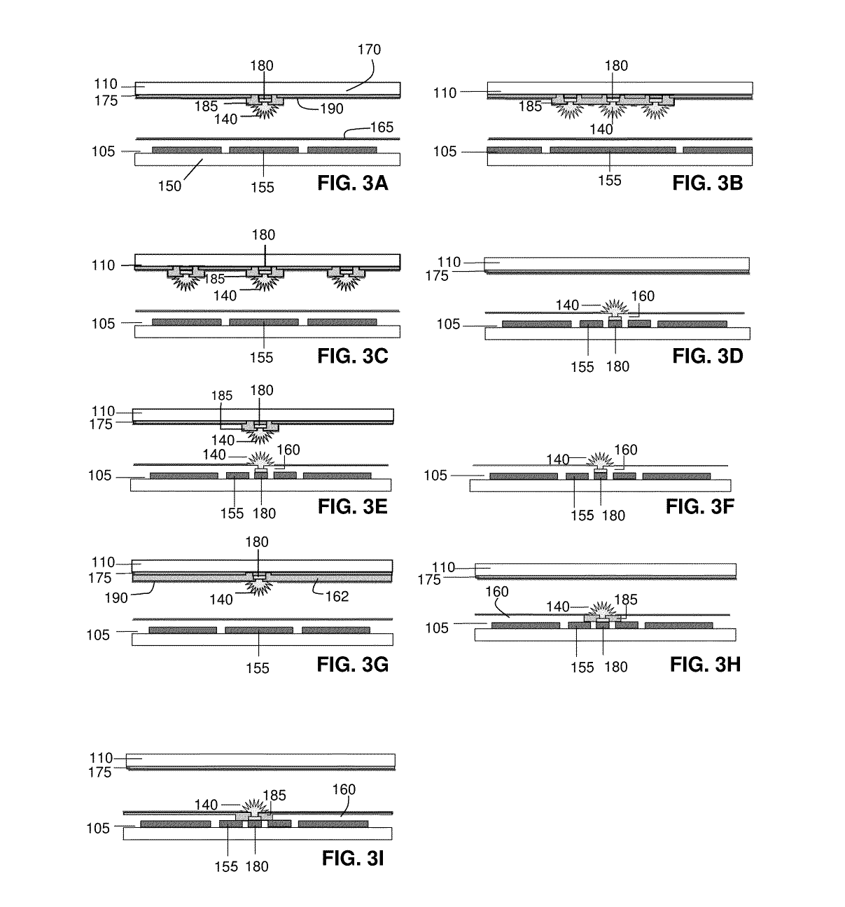

FIGS. 2A-2D show an example of a digital microfluidic device with an integrated electrochemical sensor having a working electrode formed from a nanostructured electrodeposited microelectrode. As shown in FIG. 2A, the example device 100 includes a bottom plate 105 bearing an array of digital microfluidic actuation electrodes coated with a dielectric and a hydrophobic coating, and a top plate 110 that includes the integrated electrochemical sensors.

FIG. 2B provides a detailed view of the underside of top plate 110, showing secondary electrode 120, which lies above the actuation electrode array when the device is assembled for digital microfluidic control. The detailed view of top plate 110 also includes electrodes that form an integrated electrochemical sensor, including three nanostructured electrodeposited working microelectrodes, one of which is shown at 125, an Au counter (auxiliary) electrode (CE) 130, and an Ag-plated reference electrode (RE) 135. The electrodes are accessible via contact pads 131, provided on the top plate substrate 170. As can be seen in FIG. 2A, the example device includes four such integrated electrochemical sensors, with two positioned at each end of the top plate. It will be understood that although three-electrode configuration may be preferable, the embodiments disclosed herein involving an electrochemical sensor may alternatively be implemented in a two-electrode configuration with the working and reference electrodes.

Although only one nanostructured electrodeposited working microelectrode is needed to form an electrochemical sensor, more than one working electrode may be included with each counter and reference electrode. As noted above, the embodiment illustrated in FIG. 2B shows an example implementation in which three nanostructured electrodeposited working microelectrodes are provided for each integrated electrochemical sensor, and where each nanostructured electrodeposited working microelectrode may be selectively operated to form a circuit with the associated counter 130 and reference 135 electrodes. For example, such an embodiment may be employed to produce a multiplexed integrated electrochemical biosensor that is capable of sensing multiple analytes, provided that each nanostructured electrodeposited working microelectrode is functionalized with a different analyte-specific binding agent.

An example of a nanostructured electrodeposited microelectrode 140 is shown in FIG. 2C, where the electrode has been formed having a dendritic, fractal-like morphology, exhibiting a high surface area to volume ratio. Such a nanostructured electrodeposited microelectrode may be formed according to the methods disclosed in US Patent Publication No. US2011/0233075.

The nanostructured electrodeposited microelectrodes may be comprised of a wide range of conductive materials, including a noble metal, (e.g. gold, platinum, palladium, silver, osmium, indium, rhodium, ruthenium); alloys of noble metals (e.g. gold-palladium, silver-platinum, etc.); conducting polymers (e.g. polypyrole (PPY)); non-noble metals (e.g. copper, nickel, aluminum, tin, titanium, indium, tungsten, platinum); metal oxides (e.g. zinc oxide, tin oxide, nickel oxide, indium tin oxide, titanium oxide, nitrogen-doped titanium oxide (TiOxNy); metal silicides (nickel silicide, platinum silicide); metal nitrides (titanium nitride (TiN), tungsten nitride (WN) or tantalum nitride (TaN)), carbon (nanotubes, fibers, graphene and amorphous) or combinations of any of the above.

Nanostructured electrodeposited microelectrodes may be configured or functionalized to have one or more binding agents bound thereto. In one embodiment, a binding agent may include a nucleic acid (e.g. a ribonucleic acid (RNA), deoxyribonucleic acid (DNA) or analog thereof, including, for example, a peptide nucleic acid (PNA), which contains a backbone comprised of N-(2-aminoethyl)-glycine units linked by peptides rather than deoxyribose or ribose, peptide nucleic acids, locked nucleic acids, or phosphorodiamidate morpholino oligomers. Under appropriate conditions, the probe can hybridize to a complementary nucleic acid to provide an indication of the presence of the nucleic acid in the sample. In another example embodiment, the binding agent may include a peptide or protein (e.g. antibody) that is able to bind to or otherwise interact with a biomarker target (e.g. receptor or ligand) to provide an indication of the presence of the ligand or receptor in the sample. The binding agent may include a functional group (e.g., thiol, dithiol, amine, carboxylic acid) that facilitates binding with a nanostructured electrodeposited microelectrode. Binding agents may also contain other features, such as longitudinal spacers, double-stranded and/or single-stranded regions, polyT linkers, double stranded duplexes as rigid linkers and PEG spacers.

The surface of a nanostructured electrodeposited microelectrode may be further coated with a material that maintains the electrode's high conductivity, but facilitates binding with a binding agent. For example, nitrogen containing nanostructured electrodeposited microelectrodes (e.g. TiN, WN or TaN) can bind with an amine functional group of a binding agent. Similarly, silicon/silica chemistry as part of the nanostructured electrodeposited microelectrode can bind with a silane or siloxane group on a binding agent.

FIG. 2D shows a cross-sectional profile of the example device 100, showing the integration of the nanostructured electrodeposited microelectrode into the top plate 110. Bottom plate 105 includes insulating bottom substrate 150 (e.g. glass), on which actuation electrodes 155 are formed, which are covered with dielectric layer 160, such as Parlyene-C™ and hydrophobic coating layer 165 (such as Teflon AF™ or Fluoro-Pel™). Actuation electrodes may be formed, for example, from chromium. Top plate 110 includes insulating top substrate 170 (e.g. glass), which is coated with secondary electrode 175 (e.g. ITO), such that secondary electrode 175 is positioned above actuation electrodes 155.

Nanostructured electrodeposited microelectrode 140 is formed on a base electrode, which may be formed from a single electrode layer, or from multiple electrode layers, such as layers 180, 182 and 184. Examples of base layers, as shown in the Examples section below, are ITO, Cr, and Au, respectively, for forming an Au nanostructured electrodeposited microelectrode. As shown in FIG. 2D, nanostructured electrodeposited microelectrode 140 is formed on the base electrode, via an electrodeposition (electroplating) process, such that nanostructured electrodeposited microelectrode 140 extends through an aperture surrounded by a dielectric layer 185, and into the gap region between the two plates of the device. A suitable dielectric layer is a flowing processible dielectric, such as SU-8, as further described below. Top hydrophobic layer covers secondary electrode 175, and at least a portion of the dielectric layer 185 in which the aperture is formed. The exposed dielectric layer may have a hydrophilic surface in the region surrounding the nanostructured electrodeposited microelectrode. Although not shown in FIG. 2D, similar apertures are formed within dielectric layer 185 in order to expose the other electrodes of the integrated electrochemical sensor.

Although nanostructured electrodeposited microelectrode 140 is shown directly adjacent to a specific actuation electrode, it is noted that in other embodiments, nanostructured electrodeposited microelectrode 140 may be located adjacent to the region between two actuation electrodes, as the passing of a droplet from one actuation electrode to the other actuation electrode will cause wetting and droplet retention over the hydrophilic spot associated the nanostructured electrodeposited microelectrode 140. Furthermore, it is noted that in many cases, digital microfluidic devices are employed with droplets that are larger than the actuation electrodes, and in such cases, the relative positioning of nanostructured electrodeposited microelectrode 140 and the adjacent actuation electrodes may be varied accordingly.

In the example configuration shown in FIG. 2D, the dielectric layer 185 is formed in the vicinity of the nanostructured electrodeposited microelectrode, in order to define an aperture through which the nanostructured electrodeposited microelectrode can be formed. As taught in US Patent Publication No. US2011/0233075, the nanoscale surface morphology of the nanostructured electrodeposited microelectrode is achieved via electrodeposition onto a base electrode through an aperture having at least one dimension on the micron scale. For example, it has been found that provided that one cross-sectional dimension of the aperture is approximately 30 microns or less, nanostructured electrodeposited microelectrodes are formed.

It will be understood that both cross-sectional dimensions of the nanostructured electrodeposited microelectrode need not be confined to a sub-millimeter spatial extent, and that the cross-sectional shape of the aperture need not be a shape with a low cross-sectional aspect ratio. For example, the nanostructured electrodeposited microelectrode may have a width on the order of 10 microns, while the length may extend over much longer lengths, such as up to and/or exceeding one millimeter. For example, the nanostructured electrodeposited microelectrode may be shaped such that its length extends over a tortuous path, thereby providing an increased overall surface area, with associated benefits in sensitivity and/or binding capacity.

The depth of the aperture may be selected to be on the order of 1 micron, such that the depth may range, in one example, from approximately 500 nm to approximately 8 microns, or from approximately 200 nm to approximately 10 microns. In some embodiments the aperture may have a depth between approximately 1 microns and 10 microns, or between approximately 5 microns and 8 microns.

It will be understood that although many examples provided within the present disclosure relate to digital microfluidic devices in which nanostructured electrodeposited microelectrodes are provided for electrochemical sensing, the nanostructured electrodeposited microelectrodes may be employed for other functions and purposes, and need not necessarily be provided with counter and reference electrodes for electrochemical sensing. For example, a digital microfluidic device may include a nanostructured electrodeposited microelectrode for surface-enhanced Raman scattering, or as a high-surface area region for performing binding assays, or for example, for local electrical measurements such as impendence sensing. Furthermore, the signal generated from a nanostructured electrodeposited microelectrode need not be electrical, and can be optical, such as an electrochemiluminescent signal.

The example configuration shown in FIGS. 2A-2D represents but one example implementation of the integration of a nanostructured electrodeposited microelectrode with a digital microfluidic device. In that example, nanostructured electrodeposited microelectrodes were integrated in the top plate of a two-plate digital microfluidic device. In other embodiments, nanostructured electrodeposited microelectrodes may be integrated in one or both of the top and bottom plates of a two-plate device, or, for example, in a single-plate (i.e. open) digital microfluidic device.

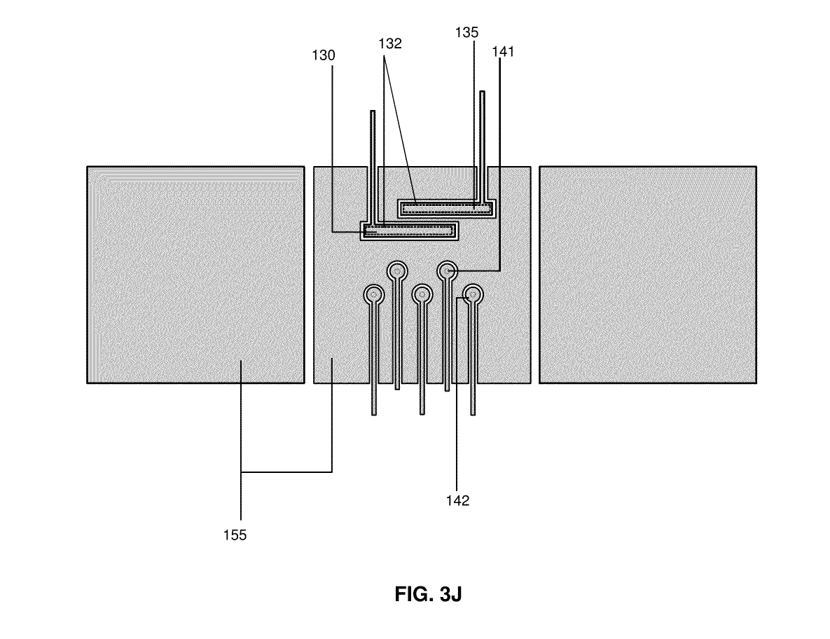

FIGS. 3A-3I provide non-limiting examples of different configurations of digital microfluidic devices with integrated nanostructured electrodeposited microelectrodes. In FIG. 3A, a configuration is shown that is similar to the one illustrated in FIGS. 2A-2D, in which a two-plate digital microfluidic device includes an integrated nanostructured electrodeposited microelectrode 140 in its top plate 110. The bottom plate 105 includes bottom insulating substrate 150, actuating electrodes 155, and bottom hydrophobic layer 165. Top plate includes top insulating substrate 170, secondary electrode 175, and top hydrophobic layer 190. Nanostructured electrodeposited microelectrode 140 is formed on a base electrode 180, within an aperture defined within dielectric region 185. The nanostructured electrodeposited microelectrode 140 is located such that when the digital microfluidic actuation electrodes are actuated to transport a droplet to a location above the centre actuation electrode, the droplet contacts the nanostructured electrodeposited microelectrode 140, and is in electrical communication with the nanostructured electrodeposited microelectrode 140.

FIG. 3B shows another example implementation in which three nanostructured electrodeposited microelectrodes 140 are formed within apertures defined within a common dielectric region 185, and where the three nanostructured electrodeposited microelectrodes 140 are adjacent to a single actuating electrode. FIG. 3C, on the other hand, illustrates an example implementation in which three nanostructured electrodeposited microelectrodes 140 are formed within apertures defined within separate dielectric regions 185, and where the three nanostructured electrodeposited microelectrodes 140 are adjacent to separate actuating electrodes.

FIG. 3D illustrates an alternative example embodiment in which a nanostructured electrodeposited microelectrode 140 is formed in the bottom plate 105 of a two-plate device. In this case, nanostructured electrodeposited microelectrode 140 may be electrodeposited within an aperture formed within dielectric layer 160. The nanostructured electrodeposited microelectrode, and any additional local electrodes (such as reference and counter electrodes of an electrochemical sensor) may formed such that they are surrounded by, yet electrically isolated from, an actuation electrode 155. FIG. 3E shows an alternative embodiment in which nanostructured electrodeposited microelectrodes are integrated in both the top 110 and bottom 105 plates of the device, while FIG. 3F illustrates an example embodiment in which a nanostructured electrodeposited microelectrode 140 is integrated into a single-plate device.

The incorporation of sensing electrodes within an actual array electrode is illustrated in FIG. 3J, which shows an overhead view of an example electrode configuration for fabricating an integrated electrochemical sensor within the bottom plate. The figure shows reference 130 and counter 135 electrodes, and five base electrodes 142 for forming four nanostructured electrodeposited microelectrodes, where these additional electrodes are surrounded by, yet electrically isolated from, actuation electrode 155. The location of the apertures within the overlaying dielectric layer, for forming nanostructured electrodeposited microelectrodes over the base electrodes 142 are shown at 141. Similarly, the apertures for exposing the reference 130 and counter 135 electrodes are shown at 132.

FIG. 3G illustrates an alternative embodiment of a two-plate digital microfluidic device in which a nanostructured electrodeposited microelectrode 140 is formed within an aperture defined in a dielectric layer 162 that is formed on the top layer, where dielectric layer 162 covers secondary electrode 175 and is coated with a hydrophobic layer 190.

FIG. 3H illustrates an alternative embodiment of a two-plate digital microfluidic device in which a nanostructured electrodeposited microelectrode 140 is integrated into the bottom plate 105, where an additional dielectric layer 185 is formed in the vicinity of nanostructured electrodeposited microelectrode 140, and where the aperture for forming nanostructured electrodeposited microelectrodes 140 is formed within additional dielectric layer 185. In some embodiments, additional dielectric layer 185 may be formed from a flowing processible dielectric (such as SU-8), and dielectric layer 160 may be formed from a vapour deposited dielectric (such as Parylene-C™). This approach may be beneficial in providing a dielectric layer 160 that is suited for generating appropriate fields for droplet actuation (e.g. a layer of Parylene-C™), while providing a local (i.e. provided in a region proximal to nanostructured electrodeposited microelectrode 140) separate dielectric layer 185 (e.g. SU-8) that is suited for maintaining an aperture that is not clogged with photoresist during a lift-off step for the formation of the hydrophobic coating, as described in more detail below This design may be also be employed in single-plate devices. FIG. 3I illustrates another example implementation in which the additional dielectric layer 185 forms a thin coating over the dielectric layer 160 (i.e. having a thickness less than that of dielectric layer 160, such that dielectric layer 160 is dominant), and a thicker layer in a region proximal to nanostructured electrodeposited microelectrode 140, where dielectric layer 160 has been selectively removed.

Embodiments of the present disclosure may be employed for a variety of assays that employ electrochemical detection (particularly those that require sensitive analysis of trace amounts of analyte). For example, the Examples section provided below illustrates two illustrative applications of electrochemical-based digital microfluidic assays, namely an ELISA for HIV-1 antibodies (with non-selective, unmodified nanostructured electrodeposited microelectrodes surface) and a nucleic acid hybridization assay for the detection of short DNA sequences (with selective, modified nanostructured electrodeposited microelectrodes surface). In these applications, all loading, reaction, mixing, and washing steps were implemented by moving droplets on the automated digital microfluidic platform.

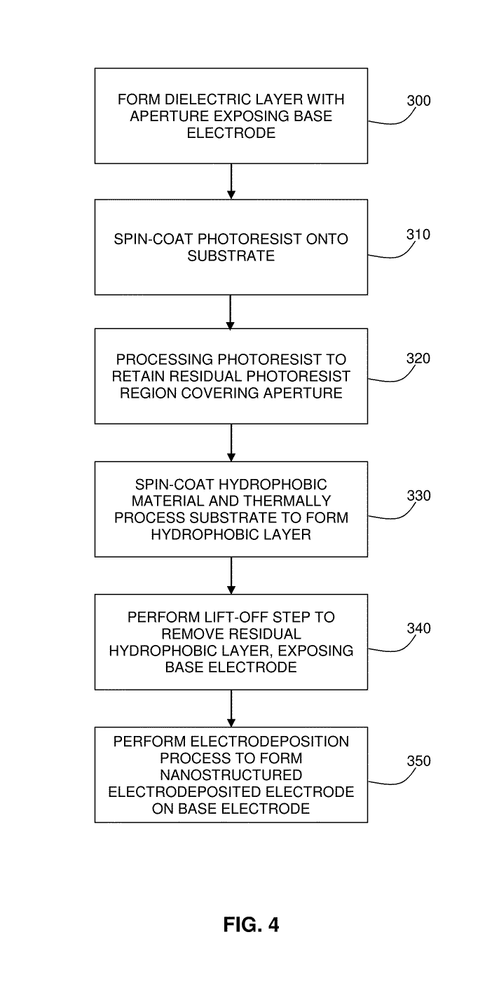

Referring now to FIG. 4, an example method is described for forming processing a substrate for the formation of a nanostructured electrodeposited microelectrode, where a lift-off step is employed to remove hydrophobic coating an expose the underlying base electrode. As noted above, nanostructured electrodeposited microelectrodes are formed by electrodeposition onto a base electrode that is provided at the bottom of an aperture, where the aperture has at least one dimension on the micron scale, and a depth that lies on the micron scale or sub-micron scale. While nanostructured electrodeposited microelectrodes have been formed on non-hydrophobic substrates in the past, the incorporation of a nanostructured electrodeposited microelectrode into a digital microfluidic device presented a new challenge, due to the need to maintain a hydrophobic surface for digital microfluidic droplet actuation. For example, even if a suitable aperture is formed in a dielectric material, exposing a base electrode within the aperture, the subsequent coating step for forming the hydrophobic layer would also coat the base electrode, preventing the electrodeposition of a nanostructured electrodeposited microelectrode on the base electrode.

In order to address this problem, a lift-off process was developed, in which a substrate, having been prepared with an aperture formed in a dielectric layer (e.g. using a patternable dielectric layer such as SU-8) and exposing a base electrode, as shown at 300 in FIG. 4, is spin-coated with a layer of photoresist, as shown at 310 in FIG. 4. The photoresist is then selectively exposed and processed to leave residual photoresist covering a region including the aperture, as shown at step 320. A hydrophobic material is then spin-coated onto the substrate in step 330, and the hydrophobic material is then thermally processed to form a hydrophobic layer, where the hydrophobic layer is formed on both the portions of the substrate with and without the residual photoresist. A lift-off step is then performed by chemically removing the residual photoresist as shown at 340, thereby lifting off the hydrophobic coating that would have otherwise covered the base electrode. Finally, electrodeposition is performed at step 350 to form the nanostructured electrodeposited microelectrode. The process may be performed using a positive tone photoresist or a negative tone photoresist.

It was found, during the development of the lift-off process, that the selection of the photoresist and the hydrophobic material can have a significant impact on the repeatability of the process. At temperatures somewhat above their typical bake temperatures (˜100° C.), positive resists soften and the edges round out, making liftoff difficult. At even higher temperatures (for example, approaching 150° C. for most positive resists), the photoresist starts cross linking, making dissolution more difficult or impossible, depending on the temperature and bake time. For example, it was found that when using Teflon-AF™ as the hydrophobic material and S1811 as the photoresist, the high baking temperature of the Teflon-AF™ and the low temperature resistance of the photoresist led to poor lift-off performance and frequent clogging of the apertures, thereby preventing electrodeposition and lowering device yield.

It was found, however, that if a hydrophobic material and a photoresist pair were selected such that the photoresist did not thermally degrade during the thermal processing of the hydrophobic layer, and where the viscosity of the photoresist was sufficient to avoid clogging of the aperture, excellent lift-off performance was obtained. In some embodiments, this may be achieved by selecting a photoresist that has a thermal resistance temperature (such that softening and cross-linking does not occur) that is greater than, or equal to, the thermal processing temperature employed for forming the hydrophobic layer. A non-limiting example of a hydrophobic material and a photoresist that have been found to meet this requirement is Fluoro-Pel™ and a PR1 series photoresist from Futurrex, such as PR1-12000A, as described in the fabrication method provided in the Examples section below. As used here, the term “thermal resistance temperature” refers to a maximum temperature at which a photoresist can be thermally processed without appreciable softening and crosslinking, such that lift-off from the aperture-region is successful.

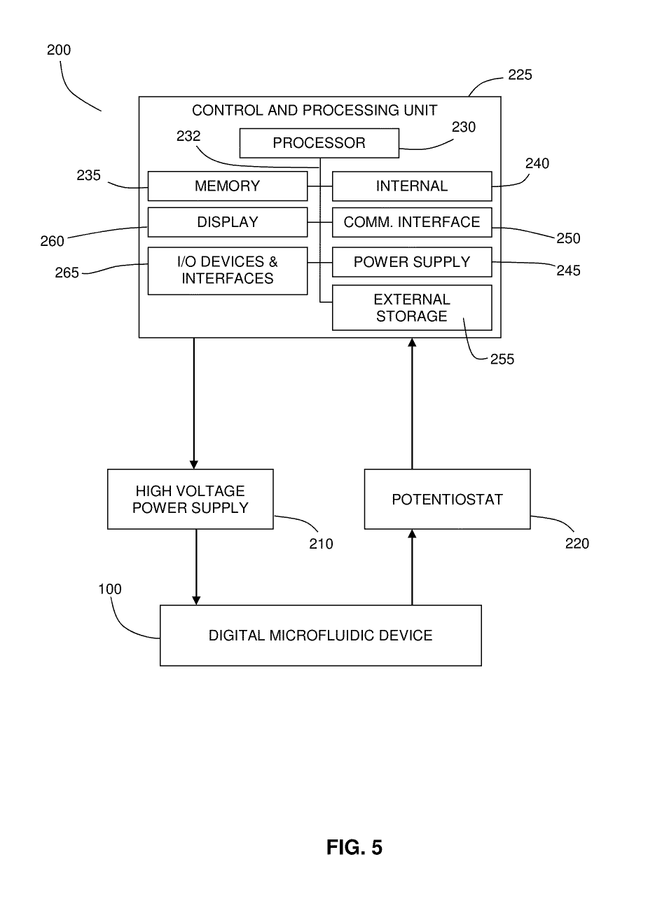

Referring now to FIG. 5, an illustration is provided of an example system 200 for controlling digital microfluidic droplet actuation and performing electrochemical measurements. As shown in FIG. 5, the digital microfluidic actuation electrodes, and the secondary electrode, are connected to, or connectable, to a high voltage power supply, which is controlled by a controlling and processing unit 225. The electrochemical sensing system is controlled by potentiostat 220, which is controlled and/or interrogated by control and processing unit 225. Although high voltage supply 210 and potentiostat 220 are shown as separate system components, it will be understood that two or more system components can be integrated into a single assembly.

As described above, in some embodiments, the dielectric layer in which the aperture is formed may be SU-8, which is readily patternable to create the aperture. However, it will be understood that other dielectric materials may be used, such as, but not limited to, Parylene-C™, amorphous fluoropolymers (Teflon-AF™ and Fluoro-Pel™), silicon nitride, silicon oxide, and PDMS. These options vary in their ease of deposition and patternability. Some of these example dielectric materials are suitable for use with a lift-off process, while others be used with plasma etching via RIE for aperture formation.

For example, for non-photopatternable materials, such as Parylene-C™ apertures could be made using the following procedures: (a) once the insulating layer has been deposited on the electrodes, a sufficiently thick layer of photoresist that withstands plasma etching can be applied, exposed, and developed. This layer of photoresist will act as a protective mask, revealing only the areas of the underlying insulator that are to be etched. The insulator is then dry-etched using reactive ion etching (RIE) until the metal layer is exposed. The photoresist then needs to be removed and the hydrophobic layer can be applied using a lift-off procedure to maintain access to the electrode surface through both the hydrophobic and insulating layers.

In another alternative example method, focused ion-beam milling may be employed to form a suitable aperture. Following this approach, masks are not required nor a lift-off procedure. In this case, both the hydrophobic and insulating layers may be ablated, revealing the electrode underneath.

Photoresists with potentially suitable dielectric properties for digital microfluidics include AZ 9200 and SU-8 that have been doped with barium titanate nanoparticles, and negative resists doped with barium titanate.

In yet another example method for generating a suitable aperture involves the preparation of a separate dielectric film, for example, as taught in U.S. Pat. No. 8,187,864. If the dielectric film is prepared with a hydrophobic coating and aperture(s), it could be adhered to the digital microfluidic substrate with precision alignment (optionally using alignment markings).

In order to prepare a substrate as shown, for example, in FIG. 3H or 3I, with both dielectric layer 160 and additional dielectric layer 185, the following example method may be employed. Once the metal electrodes have been prepared, a removable adhesive such as dicing tape may be placed over the areas selected for the additional dielectric layer 185. This could be achieved, for example, with high precision using a craft/vinyl cutter or crudely with scissors and tweezers. The device would then be subjected to vapour deposition of dielectric layer 160, such as Parylene-C™. Afterwards, the tape would be carefully removed and the additional dielectric 185 would be spin coated onto the device. In one example implementation, the additional dielectric could be provided to fill in the void where the adhesive tape was located (e.g. FIG. 3H), while an alternative method would involve fill the hole and coating over dielectric layer 160 with additional dielectric 185 (e.g. FIG. 3I). The latter example embodiment may be beneficial because composite dielectric layers have been shown to have better performance and higher breakdown voltages for digital microfluidic applications (e.g. A. Schultz, S. Chevalliot, S. Kuiper and J. Heikenfeld, Thin Solid Films, 2013, 534, 348-355; DOI: 10.1016/j.tsf.2013.03.008).

FIG. 5 provides an example implementation of control and processing unit 225, which includes one or more processors 230 (for example, a CPU/microprocessor), bus 232, memory 235, which may include random access memory (RAM) and/or read only memory (ROM), one or more internal storage devices 240 (e.g. a hard disk drive, compact disk drive or internal flash memory), a power supply 245, one more communications interfaces 250; external storage 255, a display 260 and various input/output devices and/or interfaces 255 (e.g., a user input device, such as a keyboard, a keypad, a mouse, a position tracked stylus, a position tracked probe, a foot switch, and/or a microphone for capturing speech commands).

Although only one of each component is illustrated in FIG. 5, any number of each component can be included in the control and processing unit 225. For example, a computer typically contains a number of different data storage media. Furthermore, although bus 232 is depicted as a single connection between all of the components, it will be appreciated that the bus 232 may represent one or more circuits, devices or communication channels which link two or more of the components. For example, in personal computers, bus 232 often includes or is a motherboard.

In one embodiment, control and processing unit 225 may be, or include, a general purpose computer or any other hardware equivalents. Control and processing unit 225 may also be implemented as one or more physical devices that are coupled to processor 230 through one of more communications channels or interfaces. For example, control and processing unit 225 can be implemented using application specific integrated circuits (ASICs). Alternatively, control and processing unit 225 can be implemented as a combination of hardware and software, where the software is loaded into the processor from the memory or over a network connection.

Control and processing unit 225 may be programmed with a set of instructions which when executed in the processor causes the system to perform one or more methods described in the disclosure. Control and processing unit 225 may include many more or less components than those shown.

While some embodiments have been described in the context of fully functioning computers and computer systems, those skilled in the art will appreciate that various embodiments are capable of being distributed as a program product in a variety of forms and are capable of being applied regardless of the particular type of machine or computer readable media used to actually effect the distribution.

A computer readable medium can be used to store software and data which, when executed by a data processing system causes the system to perform various methods. The executable software and data can be stored in various places including for example ROM, volatile RAM, non-volatile memory and/or cache. Portions of this software and/or data can be stored in any one of these storage devices. In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like.

Some aspects of the present disclosure can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version. Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's) and field-programmable gate arrays (FPGAs).

FIG. 5 is an illustration of an example method of transporting a liquid droplet relative to a nanostructured electrodeposited microelectrode for increasing mixing and binding kinetics. Diffusion limited mass transfer of sample to the nanostructured microelectrode surface can be enhanced by moving a sample over and around the nanostructured microelectrodes. In the case of a nanostructured microelectrode that has been modified with a surface capture moiety (e.g. an antibody or nucleic acid hybridization probe) mass transfer of an analyte to the capture surface of the nanostructured microelectrode is limited by diffusion. Turbulent flows within the droplet as a result of its moving from one electrode to another disrupt the gradients responsible for diffusion and increase interactions between the surface bound capture moiety and the target analyte. This process can result in enhanced binding kinetics and decrease assay time. Additionally, unlike lateral flow delivery of a sample (e.g. microfluidic channel), the actuation electrodes allow the sample to be presented and re-presented to the nanostructured microelectrode from more than two directions.

The following examples are presented to enable those skilled in the art to understand and to practice embodiments of the present disclosure. They should not be considered as a limitation on the scope of the disclosure, but merely as being illustrative and representative thereof.

### EXAMPLES

### Example 1

### Fabrication of Two-Plate Device Using Lift-Off Process

The following method was performed to fabricate the example device shown in FIGS. 2A-2D. Bottom plates are formed from 50×75 mm glass slides coated with 100 nm Cr. In each device, the chromium is patterned by photolithography and wet etching to create an array of electrodes, wires, and contacts for digital microfluidic. This substrate is then coated with 15 g of the insulating dielectric Parylene-C. A hydrophobic layer of Fluoro-Pel™ is spin-coated and baked on the surface. The top plates are fabricated from indium-tin oxide (ITO) coated glass slides (50 mm×75 mm) that have been coated with 20 nm of Cr and 100 nm of Au. Photolithography is used to pattern the Au and Cr layers, which make up the electrodes, and the ITO is also patterned to isolate it from the metal layers.

A 7.5 μm layer of SU-8 3005 was spin-coated, exposed, and developed to create an insulating layer over the sensing electrodes with apertures exposing the electrode surfaces. The apertures for nanostructured electrodeposited microelectrodes measure 30 μm in diameter and the RE and CE measure 120×1.38 mm.

A layer of Futurrex PR1-12000A photoresist was spin-coated on the device and patterned to leave a 2.0 mm×1.5 mm patch above the sensing area. Each slide was then cut in half, forming two substrates measuring 25 mm×75 mm. Fluoro-Pel™ was spin-coated and baked on the device and then the photoresist is dissolved, lifting-off the Fluoro-Pel™ and revealing a hydrophilic area. The RE was prepared by plating Ag from a 0.3 M AgNO3 1 M NH3OH solution at −0.8 V for 5 s. nanostructured electrodeposited microelectrodes were plated by first sonicating the device in a solution of 0.5 M HCl and 20 mM HAuCl4 and then by applying a potential of 0.0 V vs Ag/AgCl for 300 or 500 s. The top and bottom plates were assembled as shown in FIG. 1A and set apart 180 μm by two layers of double-sided tape.

A detailed explanation of the processing steps of the example method is provided below. The method is performed based on the initial processing of a glass slide coated with ITO, Cr, Au, and AZ1500 photoresist.

### Metal Patterning

1. Expose slide with Au/Cr etching mask (10 s, Flood Exposure)
2. Develop in MF-321 developer (20-30 s)
3. Rinse w/ DI H₂O
4. Etch Au with Au Etchant (KI solution, ˜30-40 s)
5. Rinse w/ DI H₂O
6. Etch Cr with Cr Etchant (CR-4, ˜20-30 s)
7. Rinse w/DI H₂O
8. Strip PR (AZ300T)
9. Rinse Acetone, IPA, DI H₂O
10. Dry w/ N₂
11. Bake 2 min @ 95° C.

### ITO Patterning

1. Spin coat with PR S1811 (3000 rpm, 30 s, accl. 8)
2. Bake 2 min @ 95° C.
3. Align and expose with ITO etching mask (10 s, Soft-cont. WEC-120)
4. Develop in MF-321 developer (20-30 s)
5. Rinse w/ DI H₂O
6. Dry w/ N₂
7. Bake 1 min @ 95° C.
8. Etch in ITO etchant bath (4:2:1, by volume, HCl:H₂O:HNO₃ CAREFUL!, 8 mins)
9. Rinse w/ DI H₂O
10. Dry w/ N₂
11. Check under microscope and with multi-meter that etch process is complete
12. Bake 2 min @ 95° C.

### SU-8 Layer and Apertures

1. Spin coat with SU-8 3005 (500 rpm 10 s, 2000 rpm 40 s)
2. Bake 2 min @ 95° C.
3. Align and expose with SU-8 mask (18 s Soft-cont. WEC-140)
4. Bake 1 min @ 95° C. (immediately!)
5. Develop, with careful attention to apertures (use pipette) (SU-8 developer)
6. Rinse w/ IPA and DI H₂O
7. Bake 10 min @ 95° C.

### Fluoro-Pel™ Lift-off

1. Spin coat PR1-12000A (2300 rpm 40 s, accl.>2300 rpm/s)
2. Bake 120° C. (3 min.)
3. Align mask and expose (65.6 s, Soft-cont. WEC-120)
4. Develop in RD6 or MF-321 (3-5 min.)
5. Rinse w/ DI H₂O
6. Dry w/ N₂
7. Cut slides in half (the remaining steps can be done out of the cleanroom in LM606)
8. Spin coat 1% v/v Fluoro-Pel™ 1604V making sure to coat the edges (2000 rpm, 40 s)
9. Bake 130° C. (10 min)
10. Remove resist in flowing acetone wash
11. Rinse w/ DI H₂O
12. Dry w/ N₂
13. Bake 120° C. for 5 min

In summary, the method involves the following steps: start with a glass slide coated with ITO, Cr, Au, and PR AZ1500. Pattern the Au and Cr layers. Deposit new PR (S1811) and pattern the ITO layer, ensuring complete etching to prevent shorting of electrodes. Deposit Su-8 layer and pattern for apertures (both for nanostructured electrodeposited microelectrode and counter and reference electrodes). Deposit thick positive PR-1 12000A for Fluoro-Pel™ lift-off. Cut slides in half, for two devices each. Spin coat Fluoropel layer and be sure to coat edges of slide (otherwise droplets won't load from edge). Remove the resist by vigorously washing in acetone. Bake to finish processing the Fluoro-Pel™ layer.

### Example 2

### ELISA Electrochemical Assay

A six-step method was developed for the ELISA. In step 1, paramagnetic microparticles coated with HIV-1 p24 antigen were loaded onto the device, where they were condensed, washed, condensed, and resuspended in a sample containing anti-HIV-1 p24 antibodies. In step 2, the particles were incubated on device with constant mixing for 3 minutes. In step 3, the particles were then condensed, repetitively washed, and then actively mixed for 3 minutes with anti-IgG conjugated to alkaline phosphatase. In step 4, the particles were condensed, repetitively washed, and then actively mixed for 10 min with a solution containing 0.5 mM p-aminophenyl phosphate. In step 5, the particles were then condensed and the solution was moved to the nanostructured electrodeposited microelectrodes sensing area. In step 6, differential pulse voltammetry (DPV) was used to detect p-aminophenyl, which is proportional to the concentration of anti-HIV-1 p24 antibodies.

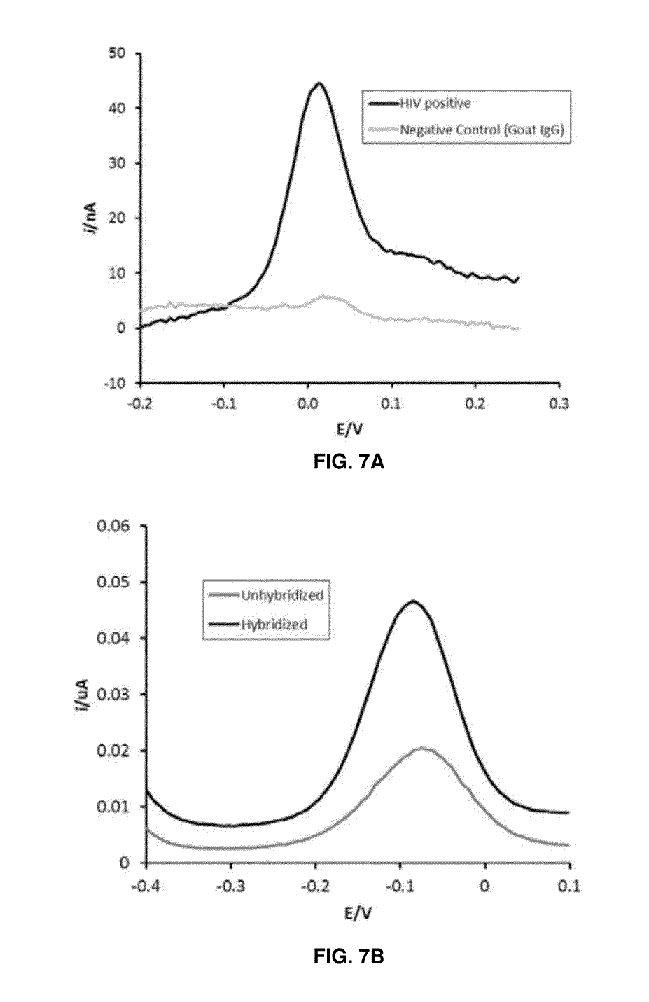

FIG. 7A shows DPV results from following the above protocol for anti-HIV-1 p24 antibodies and demonstrates the selectivity of the assay. The catalysis of the substrate p-aminophenyl phosphate by the conjugated alkaline phosphatase results in 4-aminophenol. This molecule can then be detected by the nanostructured microelectrode at a potential of approximately 0.0 V. A 5 μg/mL sample of anti-HIV-1 p24 antibodies from mouse resulted in a signal of approximately 45 nA. To demonstrate the selectivity of the assay, a sample containing 5 μg/mL of IgG from goat was processed using the same protocol and did not yield a significant signal.

### Example 3

### Molecular Electrochemical Assay

A seven-step method was developed to implement a nucleic acid assay. (1) nanostructured electrodeposited microelectrodes were modified with cysteine terminated peptide nucleic acid (PNA) probe. (2) The nanostructured electrodeposited microelectrodes were washed several times before (3) being presented with a droplet containing 10 μM Ru(NH3)6Cl3 and 1 mM K3Fe(CN)6, referred to as the electrocatalytic solution. (4) A DPV was taken, scanning for the reduction of Ru3+ to Ru2+. (5) The nanostructured electrodeposited microelectrodes was washed several times with buffer and then incubated for 30 min with a sample containing 1 μM of DNA complementary to the PNA probe. (6) The nanostructured electrodeposited microelectrodes was then washed several times and then (7) presented with the electrocatalytic solution for a second scan. The increase in peak current indicates an increase in Ru3+ electrostatically bound to the captured DNA.

FIG. 7B demonstrates the change in electrochemical signal from the reduction of Ru3+ at the nanostructured microelectrode surface. Upon hybridization of DNA with a surface bound complementary strand of PNA, there is an increase of Ru3+ at the nanostructured microelectrode surface which is reduced at −0.1 V. This results in an increase in current as compared to the unhybridized state.

### Example 4

### Performance Comparison of Au and Ag Reference Electrodes

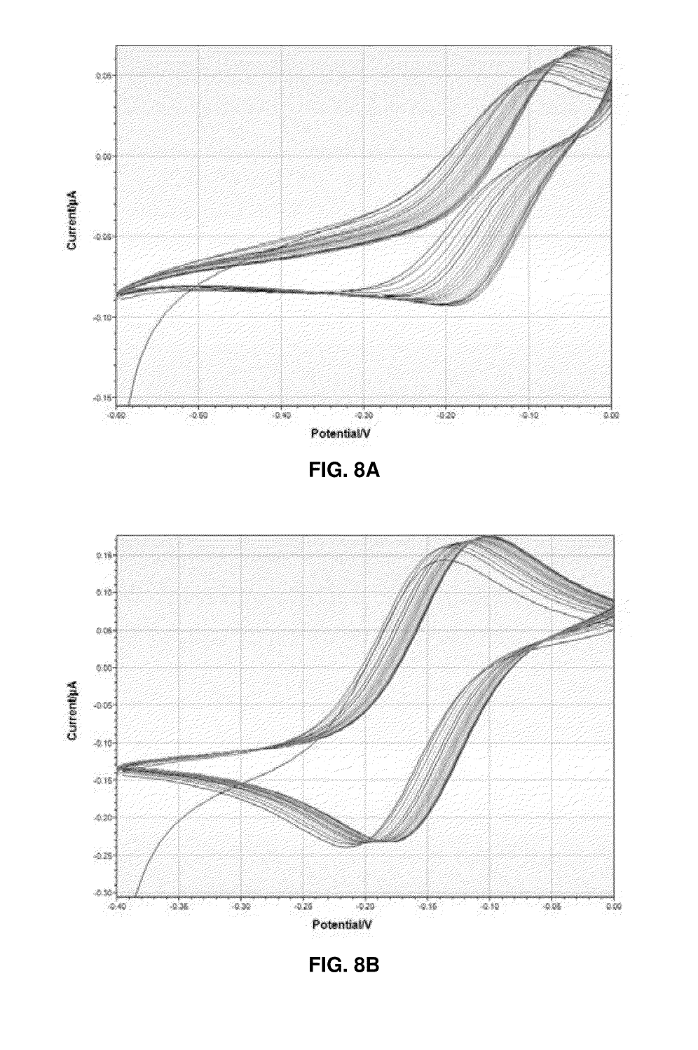

The performance of the electrochemical sensor can be enhanced by modifying the material of the reference electrode. If the reference electrode is of the same material as the nanostructured microelectrode or a counter electrode (e.g. gold), signal response can be variable. FIGS. 8A and 8B show cyclic voltammograms of the oxidation and reduction of a 2 mM K3Fe(CN)6 in a solution of phosphate buffered saline. In FIG. 8A the reference electrode is of the same gold as the counter electrode and the nanostructured microelectrode is also gold. In this case, there is potential drift over 20 cycles. Silver plating of the reference electrode, (FIG. 8B) reduces the drift in oxidation and reduction potentials. Additionally, the difference of oxidation and reduction potentials is brought in line with ideal responses. According to the Nernst equation, for a single electron transfer reaction at room temperature, the oxidation and reduction peak potentials should differ by 58 mV.

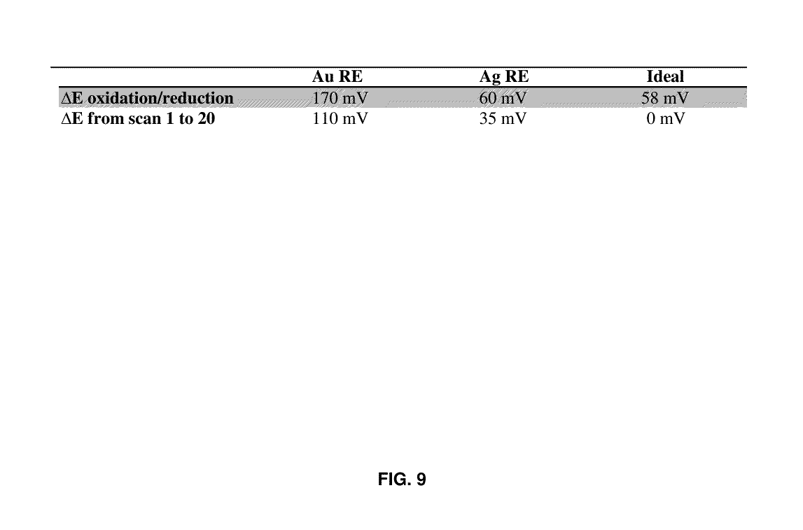

The table in FIG. 9 compares the difference in oxidation and reduction peak potentials between a nanostructured microelectrode system with a gold reference electrode and a silver reference electrode to the ideal case. In addition, the table also presents the drift in the oxidation peak over 20 successive scans.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

### REFERENCES

1. P. Dubois, G. Marchand, Y. Fouillet, J. Berthier, T. Douki, F. Hassine, S. Gmouh and M. Vaultier, Analytical Chemistry, 2006, 78, 4909-4917.
2. J. L. Poulos, W. C. Nelson, T.-J. Jeon, C.-J. C. Kim and J. J. Schmidt, Applied Physics Letters, 2009, 95, -.
3. C. Karuwan, K. Sukthang, A. Wisitsoraat, D. Phokharatkul, V. Patthanasettakul, W. Wechsatol and A. Tuantranont, Talanta, 2011, 84, 1384-1389.
4. M. D. M. Dryden, D. D. G. Rackus, M. H. Shamsi and A. R. Wheeler, Analytical Chemistry, 2013, 85, 8809-8816.
5. Y. H. Yu, J. F. Chen, J. Li, S. Yang, S. K. Fan and J. Zhou, J. Micromech. Microeng., 2013, 23.
6. M. H. Shamsi, K. Choi, A. H. C. Ng and A. R. Wheeler, Lab on a Chip, 2014, 14, 547-654.
7. X. Bin, E. H. Sargent and S. O. Kelley, Analytical Chemistry, 2010, 82, 5928-5931.
8. K. B. Cederquist and S. O. Kelley, Current Opinion in Chemical Biology, 2012, 16, 415-′421.
9. J. Das and S. O. Kelley, Analytical Chemistry, 2013, 85, 7333-7338.
10. L. Soleymani, Z. Fang, X. Sun, H. Yang, B. J. Taft, E. H. Sargent and S. O. Kelley, Angewandte Chemie International Edition, 2009, 48, 8457-8460.
11. R. Fobel, C. Fobel and A. R. Wheeler, Applied Physics Letters, 2013, 102.

Therefore what is claimed is:

1. A digital microfluidic device comprising:
a first substrate comprising an array of actuation electrodes, wherein said array of actuation electrodes is coated with a first dielectric layer and a first hydrophobic coating layer;
a second substrate comprising at least one secondary electrode, wherein said secondary electrode has formed thereon at least a second hydrophobic coating layer, wherein said second substrate is provided in a spaced relationship relative to said first substrate, defining a gap therebetween for droplet translation under electrical actuation of said array of actuation electrodes;
at least one integrated electrochemical sensor located on said first substrate or said second substrate, said integrated electrochemical sensor comprising:
a reference electrode formed within a first aperture, wherein said first aperture is surrounded by dielectric; and
a nanostructured electrodeposited working electrode extending, from a base electrode, through a second aperture surrounded by dielectric, and into said gap; and
wherein said integrated electrochemical sensor is located such that a liquid droplet is in electrical communication with said nanostructured electrodeposited working electrode and said reference electrode when the liquid droplet is transported to a selected location under actuation of said array of actuation electrodes.

2. The device according to claim 1 wherein said nanostructured electrodeposited working electrode is provided on said first substrate, and wherein first aperture and said second aperture are formed within said first dielectric layer.

3. The device according to claim 2 wherein said first aperture and said second aperture are formed in an additional dielectric layer that is provided in a region associated with said integrated electrochemical sensor.

4. The device according to claim 3 wherein said first hydrophobic coating layer is formed over at least a portion of said additional dielectric layer, such that a surface region of said additional dielectric layer that surrounds said nanostructured electrodeposited working electrode is hydrophilic.

5. The device according to claim 2 wherein said nanostructured electrodeposited working electrode is surrounded at least in part by an actuation electrode.

6. The device according to claim 2 wherein said nanostructured electrodeposited working electrode is located adjacent to said actuation electrode.

7. The device according to claim 1 wherein said nanostructured electrodeposited working electrode is provided on said second substrate.

8. The device according to claim 7 wherein said second substrate is coated with a second dielectric layer, wherein said second hydrophobic coating layer is formed on said second dielectric layer, and wherein said first aperture and said second aperture are formed within said second dielectric layer.

9. The device according to claim 7 wherein said first aperture and said second aperture are formed in an additional dielectric layer that is provided in a region associated with said integrated electrochemical sensor.

10. The device according to claim 9 wherein said second hydrophobic coating layer is formed over at least a portion of said additional dielectric layer, such that a surface region of said additional dielectric layer that surrounds said nanostructured electrodeposited working electrode is hydrophilic.

11. The device according to claim 1 wherein said nanostructured electrodeposited working electrode comprises one or more binding agents configured for the binding of an analyte thereto.

12. The device according to claim 1 wherein said integrated electrochemical sensor further comprises a counter electrode.

13. The device according to claim 1 wherein said integrated electrochemical sensor further comprises one or more additional nanostructured electrodeposited working electrodes.

14. The device according to claim 19 wherein said integrated electrochemical sensors are provided in both said first substrate and said second substrate.

15. A digital microfluidic device comprising:
a substrate comprising an array of actuation electrodes, wherein said array of actuation electrodes is coated with a dielectric layer and a hydrophobic coating layer;
said substrate further comprising at least one secondary electrode for applying a potential to each actuation electrode;
at least one integrated electrochemical sensor located on said substrate, said integrated electrochemical sensor comprising:
a reference electrode formed within a first aperture, wherein said first aperture is surrounded by dielectric; and
a nanostructured electrodeposited working electrode extending, from a base electrode, through a second aperture surrounded by dielectric and into a region beyond said hydrophobic coating layer; and
wherein said integrated electrochemical sensor is located such that a liquid droplet is in electrical communication with said nanostructured electrodeposited working electrode and said reference electrode when the liquid droplet is transported to a selected actuation electrode under actuation of said array of actuation electrodes.

16. The device according to claim 15 wherein said substrate is coated with a second dielectric layer, wherein said hydrophobic coating layer is formed on said second dielectric layer, and wherein said first aperture and said second aperture are formed within said second dielectric layer.

17. The device according to claim 15 wherein said first aperture and said second aperture are formed in an additional dielectric layer that is provided in a region associated with said integrated electrochemical sensor.

18. The device according to claim 17 wherein said hydrophobic coating layer is formed over at least a portion of said additional dielectric layer, such that a surface region of said additional dielectric layer that surrounds said nanostructured electrodeposited working electrode is hydrophilic.

19. The device according to claim 15 wherein said nanostructured electrodeposited working electrode comprises one or more binding agents configured for the binding of an analyte thereto.

20. The device according to claim 15 wherein said integrated electrochemical sensor further comprises a counter electrode.

21. The device according to claim 15 wherein said integrated electrochemical sensor further comprises one or more additional nanostructured electrodeposited working electrodes.

22. The device according to claim 15 further comprising one or more additional integrated electrochemical sensors.

23. A digital microfluidic device comprising:
a first substrate comprising an array of actuation electrodes, wherein said array of actuation electrodes is coated with a first dielectric layer and a first hydrophobic coating layer;
a second substrate comprising at least one secondary electrode, wherein said secondary electrode has formed thereon at least a second hydrophobic coating layer, wherein said second substrate is provided in a spaced relationship relative to said first substrate, defining a gap therebetween for droplet translation under electrical actuation of said array of actuation electrodes; and
a nanostructured electrodeposited electrode provided on said first substrate or said second substrate, said nanostructured electrodeposited electrode extending, from a base electrode, through an aperture surrounded by dielectric, and into said gap; and
wherein said nanostructured electrodeposited electrode is located such that a liquid droplet is in electrical communication with said nanostructured electrodeposited electrode when the liquid droplet is transported to a selected location under actuation of said array of actuation electrodes.
